(19) United States
(12) Patent Application Publication
(10) Pub. No.: US 2013/0154403 A1
(43) Pub. Date: Jun. 20, 2013

(54) VIBRATOR

(71) Applicants: Jung Taek HONG, Suwon (KR); Dae Lyun Kang, Suwon (KR)

(72) Inventors: Jung Taek HONG, Suwon (KR); Dae Lyun Kang, Suwon (KR)

(73) Assignee: SAMSUNG ELECTRO-MECHANICS CO., LTD.

(21) Appl. No.: 13/419,015

(22) Filed: Mar. 13, 2012

(30) Foreign Application Priority Data
Dec. 15, 2011 (KR) 10-2011-0135251

(51) Int. Cl. H02K 33/00

(52) U.S. Cl. 310/25

(57) ABSTRACT

There is provided a vibrator, including: a case having an inner space; a vibration generating part mounted in the case and generating vibrations by power supplied thereto; and a resonance part resonated by the vibrations generated in the vibration generating part.

### CROSS-REFERENCE TO RELATED APPLICATIONS

This application claims the priority of Korean Patent Application No. 10-2011-0135251 filed on Dec. 15, 2011, in the Korean Intellectual Property Office, the disclosure of which is incorporated herein by reference.

### BACKGROUND OF THE INVENTION

1. Field of the Invention

The present invention relates to a vibrator.

2. Description of the Related Art

As a vibrator used in a mobile phone, a tablet PC, or the like, a plate spring type linear actuator having a long lifespan and a fast response time has been mainly used.

The linear actuator has a limitation in increasing the amount of vibrations due to a restriction in the size thereof.

However, as mobile phones and the tablet PCs use various vibration modes, a tendency for differentiating a haptic feedback function has become more apparent.

In order to faithfully realize the haptic feedback function, there is a need to increase the amount of vibrations of the vibrator.

Further, there is a need to develop a technology of reducing power consumption and increasing vibrations in mobile phones and tablet PCs.

A linear vibrator including a plate spring is disclosed in Korean Patent Laid-Open Publication No. 2011-0125988 and Korean Patent Laid-Open Publication No. 2011-0125987.

### SUMMARY OF THE INVENTION

An aspect of the present invention provides a vibrator capable of increasing the amount of vibrations without increasing power consumption.

According to an aspect of the present invention, there is provided a vibrator, including: a case having an inner space; a vibration generating part mounted in the case and generating vibrations by power supplied thereto; and a resonance part resonated by the vibrations generated in the vibration generating part.

The case may have a first space part having the vibration generating part mounted therein, and a second space part connected to the first space part and having the resonance part mounted therein.

The vibration generating part may include: a magnet fixedly mounted in a central portion of the first space part; a first elastic member having a through hole through which the magnet penetrates and having an edge fixedly mounted in the case; a coil fixedly mounted on the first elastic member so as to be disposed around the through hole; a first mounting member fixedly mounted on the first elastic member so as to be disposed outwardly of the coil in a radial direction; and a first weight member fixedly mounted on the first mounting member.

The vibration generating part may further include a circuit board drawn out to the outside of the case and connected to the coil.

The elastic member may include a mounting part fixedly mounted in the case, an elastic part extending from the mounting part and being elastically stretched, and a support part extending from the elastic part and having the through hole.

The resonance part may include: a second elastic member having an edge fixedly mounted in the case so as to be disposed in the second space part; a second mounting member fixedly mounted on a top portion of the second elastic member; and a second weight member fixedly mounted on the second mounting member.

The vibration generating part may include: a first elastic member having an edge fixedly mounted in the case so as to be disposed in the first space part; a first mounting member fixedly mounted on a top surface of the first elastic member; a magnet fixedly mounted in a central portion of the first mounting member; a first weight member fixedly mounted on an outer peripheral surface of the first mounting member; and a coil fixedly mounted in the case so as to face the magnet.

The resonance part may include: a second elastic member having an edge fixedly mounted in the case so as to be disposed in the second space part; a second mounting member fixedly mounted on a top surface of the second elastic member; and a second weight member fixedly mounted on an outer peripheral surface of the second mounting member.

The vibration generating part may further include a yoke mounted on a top surface of the magnet.

The vibration generating part may further include a buffer member mounted in the case so as to be disposed within the coil.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic view of a vibrator according to an embodiment of the present invention;

FIG. 2 is an exploded perspective view of a vibrator according to an embodiment of the present invention;

FIG. 3 is a schematic perspective view of a vibrator according to an embodiment of the present invention;

FIG. 4 is a schematic cross-sectional view of a vibrator according to another embodiment of the present invention; and

FIG. 5 is an exploded perspective view of a vibrator according to another embodiment of the present invention.

### DETAILED DESCRIPTION OF THE EMBODIMENTS

Embodiments of the present invention will now be described in detail with reference to the accompanying drawings. However, it should be noted that the spirit of the present invention is not limited to the embodiments set forth herein and those skilled in the art and understanding the present invention could easily accomplish retrogressive inventions or other embodiments included in the spirit of the present invention by the addition, modification, and removal of components therein, but those are to be construed as being included in the spirit of the present invention.

Further, when it is determined that a detailed description of the known art, related to the present invention, may obscure the gist of the present invention, a detailed description thereof will be omitted.

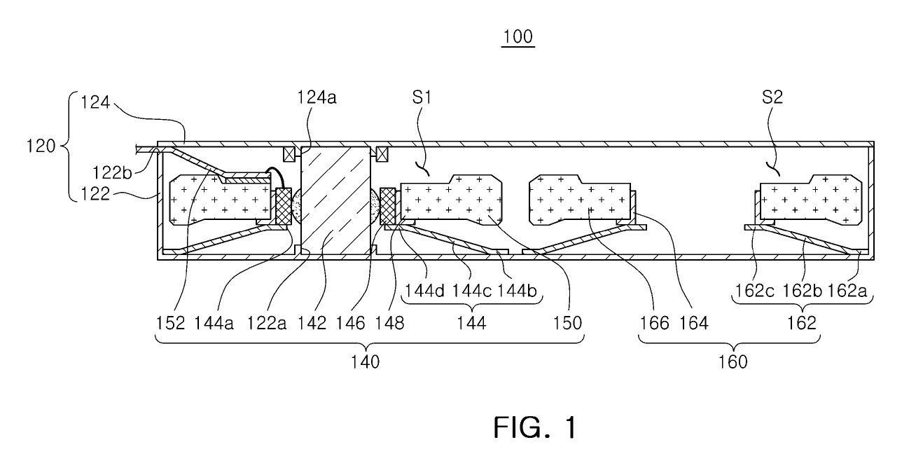

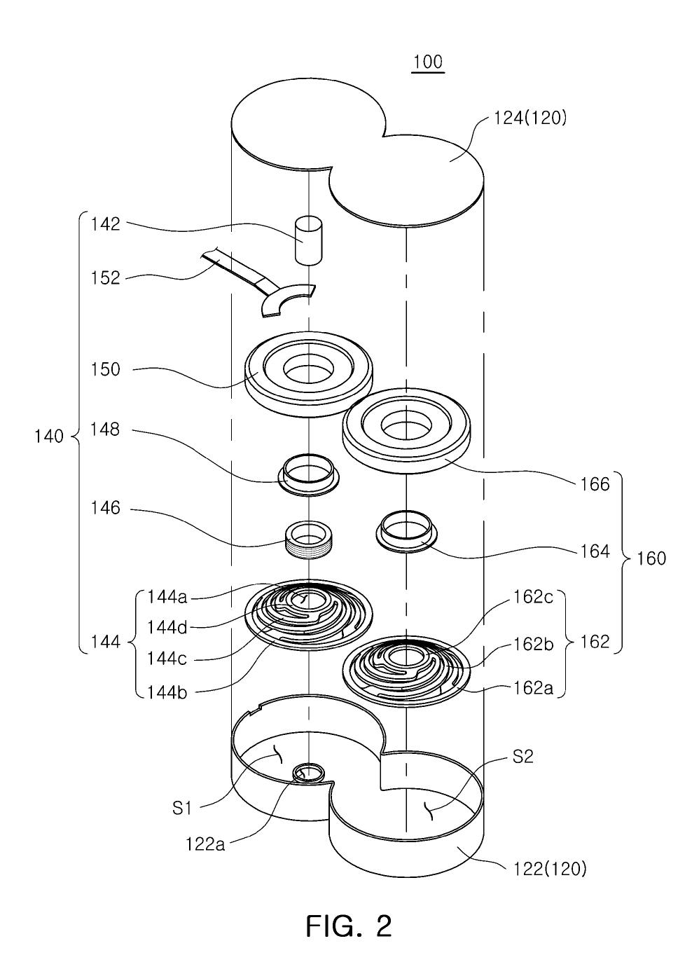

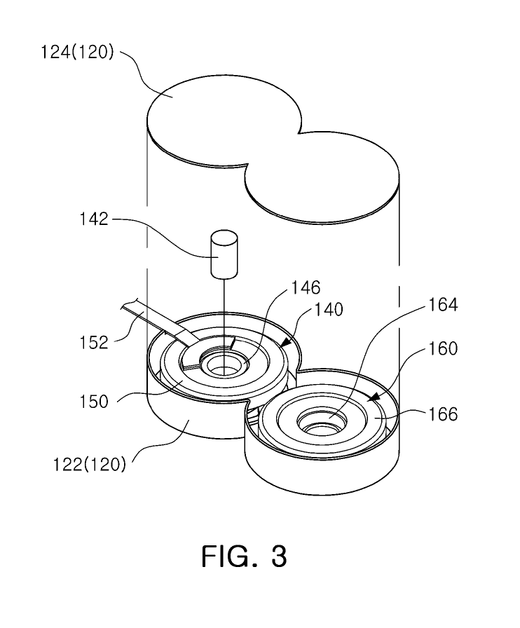

FIG. 1 is a schematic view of a vibrator according to an embodiment of the present invention, FIG. 2 is an exploded perspective view of the vibrator according to the embodiment of the present invention, and FIG. 3 is a schematic perspective view of the vibrator according to the embodiment of the present invention.

Referring to FIGS. 1 to 3, a vibrator 100 according to an embodiment of the present invention may include a case 120, a vibration generating part 140, and a resonance part 160.

The case 120 has an inner space in which the vibration generating part 140 and the resonance part 160 are mounted. That is, the case 120 has a first space part S1 in which the vibration generating part 140 is mounted and a second space part S2 connected to the first space part S1 and having the resonance part 160 mounted therein.

Further, the case 120 may have a substantially ‘8’-letter shape when being viewed from the top.

Meanwhile, the case 120 may include a lower case 122 having a concave shape and an upper case 124 coupled to the lower case 122.

Further, the lower case 122 may have a mounting groove 122a in which a magnet 142 (to be described later) forming the vibration generating part 140 is mounted.

Further, the lower case 122 may be provided with a drawing hole 122b through which a circuit board 152 (to be described later) forming the vibration generating part 140 is drawn.

Further, the upper case 124 may have a mounting groove 124a disposed above the mounting groove 122a.

The vibration generating part 140 is mounted within the case 120 and generates vibrations by power supplied thereto. That is, the vibration generating part 140 is mounted in the first space part S1 and serves to generate vibrations.

Meanwhile, the vibration generating part 140 may include, for example, the magnet 142, a first elastic member 144, a coil 146, a first mounting member 148, a first weight member 150, and the circuit board 152.

The magnet 142 may be fixedly mounted in a central portion of the first space part S1. That is, a lower portion of the magnet 142 is inserted into the mounting groove 122a formed in the lower case 122 and an upper portion thereof is inserted into the mounting groove 124a formed in the upper case 124.

Further, the magnet 142 may have a cylindrical shape and may be disposed in the central portion of the first space part S1.

The first elastic member 144 has a through hole 144a through which the magnet 142 penetrates and an edge thereof may be fixedly mounted in the case 120.

That is, the first elastic member 144 serves to provide a restoring force when the first mounting member 148 and the first weight member 150 are vibrated vertically.

Further, the first elastic member 144 may include a mounting part 144b fixedly mounted in the case 120, an elastic part 144c extending from the mounting part 144b and being elastically stretched, and a support part 144d extending from the elastic part 144c and having the through hole 144a.

The mounting part 144b has a circular ring shape and is fixedly mounted on a bottom surface of the lower case 122. Further, the mounting part 144b may be bonded to the lower case 122 by an adhesive.

Further, the elastic part 144c connects the mounting part 144b to the support part 144d and is stretched when the vibrations are generated.

The support part 144d may have a ring shape and have the through hole 144a in the center thereof such that the magnet 142 may penetrate therethrough. Further, the coil 146 and the first mounting member 148 may be fixedly mounted on the top surface of the support part 144d.

The coil 146 may be fixedly mounted on the first elastic member 144 so as to be disposed around the through hole 144a. The coil 146 may be fixedly mounted on the support part 144d so as to be disposed to face the magnet 142.

That is, the coil 146 has a cylindrical shape and the magnet 142 is inserted into the inside of the coil 146.

Meanwhile, when power is applied to the coil 146, the coil 146 is vertically vibrated by electromagnetic interaction between the coil 146 and the magnet 142. That is, when alternating current having a resonance frequency is applied to the coil 146, the coil 146 vertically moves by the electromagnetic interaction between the coil 146 and the magnet 142 to thereby generate vibrations.

The first mounting member 148 may be fixedly mounted on the first elastic member 144 so as to be disposed outwardly of the coil 146 in a radial direction. In other words, the first mounting member 148 may be disposed outside the coil 146 and may be fixedly mounted on the support part 144d of the first elastic member 144.

Further, the first mounting member 148 may have a ring shape having a transverse section in a ‘ [symbol] ’-letter shape so as to be installed with the first weight member 150.

The first weight member 150 may be fixedly mounted on the first mounting member 148. Further, the first weight member 150 allows for the maintenance of vibrations when a driving force is generated by the electromagnetic interaction between the coil 146 and the magnet 142.

Here, the vibration generating operation will be described.

That is, when the alternating current having the resonance frequency is applied to the coil 146, the driving force is generated by the electromagnetic interaction between the coil 146 and the magnet 142 to thereby vibrate the coil 146.

Therefore, the driving force is transferred to the first elastic member 144 to vertically vibrate the coil 146, the first mounting member 148, and the first weight member 150.

The circuit board 152 is drawn out to the outside of the case 120 and is connected to the coil 146 to serve to apply power to the coil 146.

Meanwhile, the circuit board 152 may include a flexible circuit board, and one end thereof may be connected to the coil 146 and the other end thereof may be drawn to the outside through the drawing groove 122b of the lower case 122.

Further, the circuit board 152 may be connected to the coil 146 while being fixedly mounted on the first weight member 150.

The resonance part 160 may be vibrated by vibrations generated from the vibration generating part 140.

Meanwhile, the resonance part 160 may include a second elastic member 162, a second mounting member 164, and a second weight member 166.

An edge of the second elastic member 162 may be fixedly mounted in the case 120. That is, the second elastic member 162 may be fixedly mounted in the lower case 122 so as to be disposed in the second space part S2.

Further, the second elastic member 162 serves to provide a restoring force when the second mounting member 164 and the second weight member 166 are vibrated.

Further, the second elastic member 162 may include a mounting part 162a fixedly mounted in the case 120, an elastic part 162b extending from the mounting part 162a and being elastically stretched, and a support part 162c extending from the elastic part 162b.

The mounting part 162a has a circular ring shape and is fixedly mounted on the bottom surface of the lower case 122. Further, the mounting part 162a may be bonded to the lower case 122 by an adhesive.

Further, the elastic part 162b connects the mounting part 162a to the support part 162c and is stretched when the vibrations are generated.

The support part 162c is extended from the elastic part 162b and the second mounting member 164 may be fixedly mounted on the top surface of the support part 162c. Meanwhile, the support part 162c in the embodiment of the present invention has a ring shape, but is not limited thereto. The support part 162c may have a disc shape.

The second mounting member 164 may be fixedly mounted on the top portion of the second elastic member 162. Further, the second mounting member 164 may have a ring shape having a longitudinal section in a ‘ [symbol] ’-letter shape so as to be fixedly installed with the second weight member 166.

The second weight member 166 may be fixedly mounted on the second mounting member 164.

Meanwhile, the resonance part 160 may be vibrated at the same resonance frequency as that of the vibration generating part 140. That is, the second weight member 166 and the second elastic member 162 may be vibrated at the same resonance frequency as that of the vibration generating part 140.

As described above, the resonance part 160 may include the second elastic member 162, the second mounting member 164, and the second weight member 166, such that the resonance part 160 may generate vibrations without being supplied with power from the outside when the vibrations are generated from the vibration generating part 140.

That is, the resonance part 160 may be vibrated by the vibrations generated from the vibration generating part 140 to thereby increase the amount of vibrations. In other words, the resonance part 160 may be resonated by the vibrations generated from the vibration generating part 140 to thereby increase the amount of vibrations.

Further, even in the case that the vibration generating part 140 is not connected to the resonance part 160 by a separate vibration transfer member, the resonance part 160 may be resonated by the vibrations generated from the vibration generating part 140, and therefore, the amount of vibrations may be more increased with the same amount of power consumption.

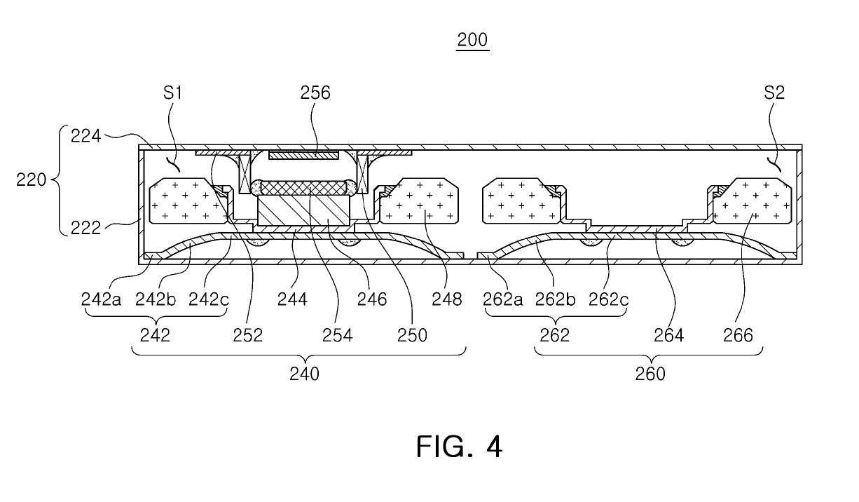

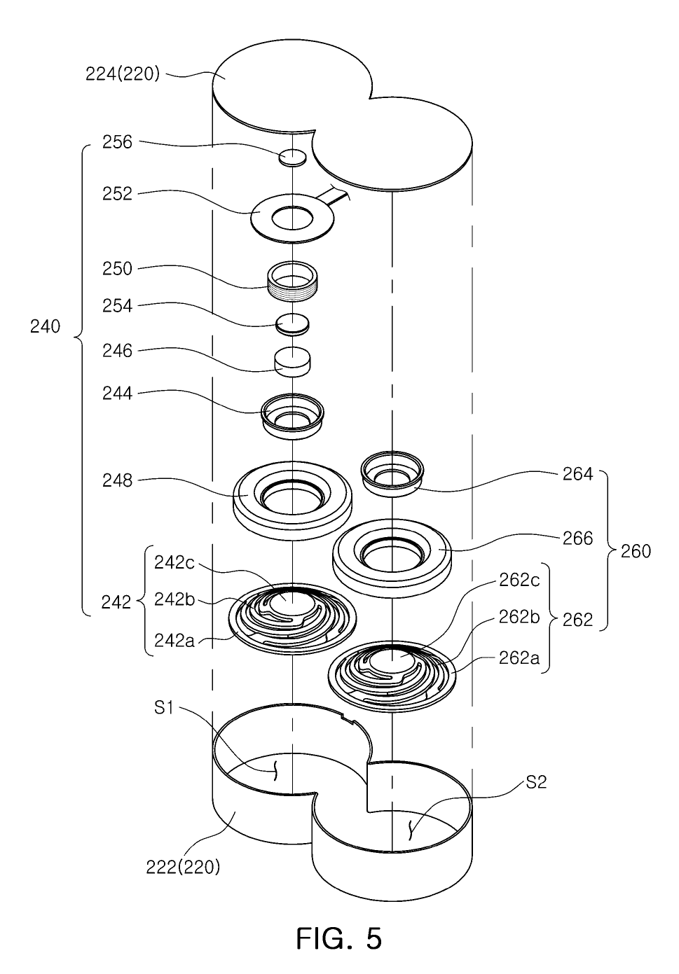

Hereinafter, a vibrator according to another embodiment of the present invention will be described with reference to FIGS. 4 and 5.

FIG. 4 is a schematic cross-sectional view of a vibrator according to another embodiment of the present invention, and FIG. 5 is an exploded perspective view of a vibrator according to another embodiment of the present invention.

Referring to FIGS. 4 and 5, a vibrator 200 according to another embodiment of the present invention may include, for example, a case 220, a vibration generating part 240, and a resonance part 260.

The case 220 has an inner space in which the vibration generating part 240 and the resonance part 260 are mounted. That is, the case 220 has a first space part S1 having the vibration generating part 240 mounted therein and a second space part S2 connected to the first space part S1 and having the resonance part 260 mounted therein.

Further, the case 220 may have a substantially ‘8’-letter shape when being viewed from the top.

Meanwhile, the case 220 may include a lower case 222 having a concave shape and an upper case 224 coupled to the lower case 222.

The vibration generating part 240 is mounted in the case 220 and generates vibrations by power supplied thereto. Further, the vibration generating part 240 may be mounted in the first space part S1.

Meanwhile, the vibration generating part 240 may include a first elastic member 242, a first mounting member 244, a magnet 246, a first weight member 248, and a coil 250.

An edge of the first elastic member 242 may be fixedly mounted in the case 220 so as to be disposed in the first space part S1. That is, the edge of the first elastic member 242 may be fixedly mounted in the lower case 222 so as to be disposed in the first space part S1.

Further, the first elastic member 242 may include a mounting part 242a fixedly mounted in the lower case 222, an elastic part 262b extending from the mounting part 242a and being elastically stretched, and a support part 242c extending from the elastic part 262b.

The mounting part 242a has a circular ring shape and is fixedly mounted on the bottom surface of the lower case 222. Further, the mounting part 242a may be bonded to the lower case 222 by an adhesive.

Further, the elastic part 242b connects the mounting part 242a to the support part 242c and is stretched when the vibrations are generated.

The support part 242c is extended from the elastic part 242b and the first mounting member 244 may be fixedly mounted on the top surface of the support part 242c. Meanwhile, the support part 242c may have a disc shape.

As described above, the first mounting member 244 may be fixedly mounted on the top surface of the support part 242c of the elastic member 242. Further, the first mounting member 244 may have a circular dish shape.

Meanwhile, the magnet 246 is fixedly mounted in a central portion of the first mounting member 244. That is, the magnet 246 is inserted into the central portion of the first mounting member 244 having the dish shape.

Further, the magnet 246 may have a circular transverse section.

The first weight member 248 is fixedly mounted on an outer peripheral surface of the first mounting member 244. Further, the first weight member 248 may have a circular ring shape so as to be fixedly mounted on the outer peripheral surface of the first mounting member 244.

The coil 250 may be disposed to face the magnet 246. Further, the coil 250 may be fixedly mounted on a circuit board 252 mounted in the case 220. That is, the coil 250 may be fixedly mounted on the circuit board 252 mounted on the bottom surface of the upper case 224 to be disposed to face the magnet 246.

Further, the coil 250 may have a hollow cylindrical shape such that the magnet 246 may be drawn thereinto when the elastic member 242 is stretched.

Further, when power is applied to the coil 250, a driving force is applied to the magnet 246 by the electromagnetic interaction between the coil 250 and the magnet 246. Therefore, the first mounting member 244 having the magnet 246 mounted therein and the first weight member 248 mounted on the first mounting member 244 may be vertically vibrated.

Meanwhile, the vibration generating part 240 may include a yoke 254 mounted on the top surface of the magnet 246. The yoke 254 serves to induce a magnetic field generated from the magnet to the coil 250.

In addition, the vibration generating part 240 may further include a buffer member 256 mounted in the case 220 so as to be disposed within the coil 250. The buffer member 256 serves to prevent the magnet 246 from contacting the upper case 224 when the magnet 246 is vertically vibrated.

The resonance part 260 may be vibrated by the vibrations generated from the vibration generating part 240.

Meanwhile, the resonance part 260 may include a second elastic member 262, a second mounting member 264, and a second weight member 266.

An edge of the second elastic member 262 may be fixedly mounted in the case 220. That is, the second elastic member 262 may be fixedly mounted in the lower case 222 so as to be disposed in the second space part S2.

Further, the second elastic member 262 serves to provide a restoring force when the second mounting member 264 and the second weight member 266 are vibrated.

Further, the second elastic member 262 may include a mounting part 262a fixedly mounted in the lower case 222, an elastic part 262b extending from the mounting part 262a and being elastically stretched, and a support part 262c extending from the elastic part 262b.

The mounting part 262a has a circular ring shape and is fixedly mounted on the bottom surface of the lower case 222. Further, the mounting part 262a may be bonded to the lower case 222 by an adhesive.

Further, the elastic part 262b connects the mounting part 262a to the support part 262c and is stretched when the vibrations are generated.

The support part 262c is extended from the elastic part 262b and the second mounting member 264 may be fixedly mounted on the top surface of the support part 262c. Meanwhile, the support part 262c may have a disc shape.

As described above, the second mounting member 264 may be fixedly mounted on the top surface of the support part 262c of the elastic member 262. Further, the second mounting member 264 may have a circular dish shape.

The second weight member 266 is fixedly mounted on an outer peripheral surface of the second mounting member 264. Further, the first weight member 266 may have a circular ring shape so as to be fixedly mounted on the outer peripheral surface of the second mounting member 264.

Meanwhile, the resonance part 260 may be vibrated at the same resonance frequency as that of the vibration generating part 240. That is, the second weight member 266 and the second elastic member 262 may be vibrated at the same resonance frequency as that of the vibration generating part 240.

As described above, the resonance part 260 may include the second elastic member 262, the second mounting member 264, and the second weight member 266, such that the resonance part 260 may generate vibrations without being supplied with power from the outside when the vibrations are generated from the vibration generating part 240.

That is, the resonance part 260 is vibrated by the vibrations generated from the vibration generating part 240 to thereby increase the amount of vibrations. In other words, the resonance part 260 may be resonated by the vibrations generated from the vibration generating part 240 to thereby increase the amount of vibrations.

Further, even in the case that the vibration generating part 240 is not connected to the resonance part 260 by a separate vibration transfer member, the resonance part 260 may be resonated by the vibrations generated from the vibration generating part 240, and thus, the vibrations may be more increased with the same amount of power consumption.

As set forth above, according to embodiments of the present invention, vibrations can be increased with the same amount of power consumption by amplifying the vibrations generated in a vibration generating part using a resonance part.

While the present invention has been shown and described in connection with the exemplary embodiments, it will be apparent to those skilled in the art that modifications and variations can be made without departing from the spirit and scope of the invention as defined by the appended claims.

What is claimed is:

1. A vibrator, comprising:
a case having an inner space;
a vibration generating part mounted in the case and generating vibrations by power supplied thereto; and
a resonance part resonated by the vibrations generated in the vibration generating part.

2. The vibrator of claim 1, wherein the case has a first space part having the vibration generating part mounted therein, and a second space part connected to the first space part and having the resonance part mounted therein.

3. The vibrator of claim 1, wherein the vibration generating part includes:
a magnet fixedly mounted in a central portion of the first space part;
a first elastic member having a through hole through which the magnet penetrates and having an edge fixedly mounted in the case;
a coil fixedly mounted on the first elastic member so as to be disposed around the through hole;
a first mounting member fixedly mounted on the first elastic member so as to be disposed outwardly of the coil in a radial direction; and
a first weight member fixedly mounted on the first mounting member.

4. The vibrator of claim 3, wherein the vibration generating part further includes a circuit board drawn out to the outside of the case and connected to the coil.

5. The vibrator of claim 3, wherein the elastic member includes:
a mounting part fixedly mounted in the case;
an elastic part extending from the mounting part and being elastically stretched; and
a support part extending from the elastic part and having the through hole.

6. The vibrator of claim 1, wherein the resonance part includes:
a second elastic member having an edge fixedly mounted in the case so as to be disposed in the second space part;
a second mounting member fixedly mounted on a top portion of the second elastic member; and
a second weight member fixedly mounted on the second mounting member.

7. The vibrator of claim 1, wherein the vibration generating part includes:
a first elastic member having an edge fixedly mounted in the case so as to be disposed in the first space part;
a first mounting member fixedly mounted on a top surface of the first elastic member;
a magnet fixedly mounted in a central portion of the first mounting member;
a first weight member fixedly mounted on an outer peripheral surface of the first mounting member; and
a coil fixedly mounted in the case so as to face the magnet.

8. The vibrator of claim 7, wherein the resonance part includes:
a second elastic member having an edge fixedly mounted in the case so as to be disposed in the second space part;
a second mounting member fixedly mounted on a top surface of the second elastic member; and
a second weight member fixedly mounted on an outer peripheral surface of the second mounting member.

9. The vibrator of claim 7, wherein the vibration generating part further includes a yoke mounted on a top surface of the magnet.

10. The vibrator of claim 7, wherein the vibration generating part further includes a buffer member mounted in the case so as to be disposed within the coil.
